(19) United States
(12) Patent Application Publication
(10) Pub. No.: US 2018/0029123 A1
(43) Pub. Date: Feb. 1, 2018

(54) REMOVABLE SUPPORT PACKAGE FOR ADDITIVE MANUFACTURE

(71) Applicant: General Electric Company, Schenectady, NY (US)

(72) Inventors: Fabian Gubelmann, Buchs (CH); Dariusz Oliwiusz Palys, Gebenstorf (CH); Ernst Vogt, Remigen (CH)

(21) Appl. No.: 15/223,835

(22) Filed: Jul. 29, 2016

(51) Int. Cl. B22F 3/105; B33Y 40/00; B33Y 10/00; B25B 11/00

(52) U.S. Cl. CPC B22F 3/1055; B25B 11/00; B33Y 40/00; B33Y 10/00; B22F 2003/1058

(57) ABSTRACT

Aspects of the disclosure include removable support packages for additive manufacture, in addition methods and code for manufacturing and removing the same. A removable support package for a laser-sintered component according to the present disclosure may include: a structure having opposing interior sidewalls, the opposing interior sidewalls defining a hollow interior of the structure; a plurality of supports extending between the opposing interior sidewalls of the structure; a first rod joining the plurality of supports at a first end proximal to one interior sidewall of the structure; and a second rod joining the plurality of supports at a second end proximal to another opposing interior sidewall of the structure.

### TECHNICAL FIELD

The disclosure relates generally to removable support packages for laser-sintered components, such as those produced in additive manufacture. More particularly, embodiments of the present disclosure provide methods, structures, and program code for yielding a removable support package for a laser-sintered component, such that the removable support package is formed in a hollow interior of the component.

### BACKGROUND

The pace of change and improvement in the realms of power generation, aviation, and other fields has accompanied extensive research for manufacturing components used in these fields. Conventional manufacture of metallic components generally includes milling or cutting away regions from a slab of metal before treating and modifying the cut metal to yield a part, which may have been simulated using computer models, e.g., in drafting software. Manufactured components which may be formed from metal can include, e.g., airfoil components for installation in a turbomachine such as an aircraft engine or power generation system. The development of additive manufacturing, also known in the art as “3D printing,” can reduce manufacturing costs by allowing such components to be formed more quickly, with unit-to-unit variations as appropriate. Among other advantages, additive manufacture can directly apply computer-generated models to a manufacturing process while relying on less expensive equipment and/or raw materials.

Additive manufacturing can allow a component to be formed from a reserve of fine metal powder positioned on a build plate, which is processed by an electron beam or laser (e.g., using heat treatments such as sintering) to form a component or sub-component. Additive manufacturing equipment can also form components, e.g., by using three-dimensional models generated with software included within and/or external to the manufacturing equipment. Some devices fabricated via additive manufacture can be formed initially as several distinct components at respective processing stages before being assembled in a subsequent process. One challenge associated with additive manufacturing includes maintaining the shape of a component before the manufacturing process completes. For example, some portions of a component may be structurally stable after the component has been manufactured, but may need additional structural support when some parts have not been built. Some designs may address this concern by including temporary supports which may be designed and positioned for removal after the component is manufactured. Due to variances between manufactured components and the manner in which these components are formed, the use of these supports can vary widely between component designs. The supports may also be manufactured such that they are capable of being removed only after the component is fully manufactured.

### SUMMARY

A first aspect of the disclosure provides a method for removing a support package from a laser-sintered component, the method including: providing a laser-sintered component having opposing interior sidewalls, the opposing interior sidewalls defining a hollow interior of the laser-sintered component, wherein the laser-sintered component further includes: a plurality of supports extending between the opposing interior sidewalls, a first rod joining the plurality of supports at a first end proximal to one of the opposing interior sidewalls, and a second rod joining the plurality of supports at a second end proximal to another one of the opposing interior sidewalls; striking the first rod of the laser-sintered component to dislodge the plurality of supports from one of the opposing interior sidewalls; and striking the second rod of the laser-sintered component to dislodge the plurality of supports from the other of the opposing interior sidewalls, wherein each of the plurality of supports is oriented at a non-perpendicular angle relative to the opposing interior sidewalls after the first and second rods are struck.

A second aspect of the disclosure provides a removable support package for a laser-sintered component, including: a structure having opposing interior sidewalls, the opposing interior sidewalls defining a hollow interior of the structure; a plurality of supports extending between the opposing interior sidewalls; a first rod joining the plurality of supports at a first end thereof proximal to one interior sidewall; and a second rod joining the plurality of supports at a second end thereof proximal to another interior sidewall of the structure.

A third aspect of the invention provides a non-transitory computer readable storage medium storing code representative of a removable support package for a laser-sintered component, the removable support package being physically generated upon execution of the code, the removable support package including: a structure having opposing interior sidewalls, the opposing interior sidewalls defining a hollow interior of the structure; a plurality of supports extending between the opposing interior sidewalls; a first rod joining the plurality of supports at a first end thereof proximal to one interior sidewall; and a second rod joining the plurality of supports at a second end thereof proximal to another interior sidewall of the structure.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 provides a cross-sectional view in plane X-Y of a laser-sintered component and removable support package according to embodiments of the present disclosure.

FIG. 2 provides a cross-sectional view in plane X-Z of the laser-sintered component and removable support package of FIG. 1.

FIG. 3 provides a cross-sectional view in plane X-Z of another laser-sintered component and removable support package according to embodiments of the present disclosure.

FIG. 4 provides a cross-sectional view in plane X-Y of another laser-sintered component and removable support packages according to embodiments of the present disclosure.

FIG. 5 provides a cross-sectional view in plane X-Y of a removable support package being removed according to embodiments of the present disclosure.

FIG. 6 provides a cross-sectional view in plane X-Y of a removable support package being removed according to alternative embodiments of the present disclosure.

FIG. 7 shows a block diagram of an additive manufacturing process including a non-transitory computer readable storage medium storing code representative of a component and removable support package according to embodiments of the disclosure.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be used and that changes may be made without departing from the scope of the present teachings. The following description is, therefore, merely exemplary.

Where an element or layer is referred to as being “on,” “engaged to,” “disengaged from,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

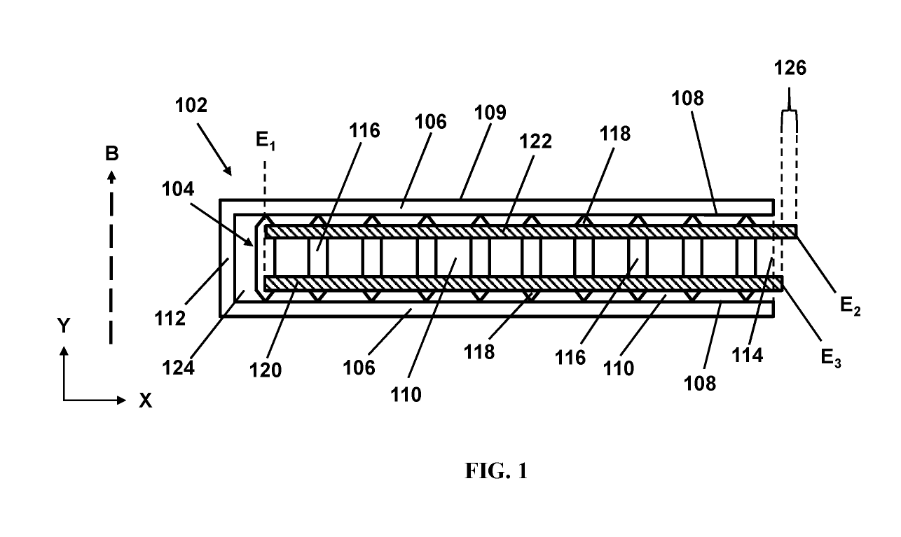

Referring to FIG. 1, the following description is directed to a laser-sintered component 102 (“component 102” hereafter) which is manufactured to include a removable support package 104 (“support package” or simply “package” 104 hereafter) therein. Component 102 may form part of, or may be adaptable to form part of, a larger component and/or machine such as a power generation assembly. It will be understood, however, that component 102 may have applications other than those described by example herein. In an example embodiment, component 102 can have a substantially cylindrical exterior with a similarly-shaped hollow interior as described elsewhere herein. Embodiments of the present disclosure also include methods for removing support package 104 from component 102, such that component 102 can be adapted to form part of another structure, machine, etc. For example, methods according to the present disclosure can include providing and/or manufacturing component 102 and support package 104 together, before striking support package 104 to mechanically separate support package 104 from component 102. The dislodged support package 104 can then be removed from component 102 by any conventional means for removing waste material(s) from the interior of a structure. Embodiments of the present disclosure also provide an additive manufacturing file (e.g., code stored on a non-transitory computer readable storage medium) representative of and used for generating component 102 and support package 104 therein.

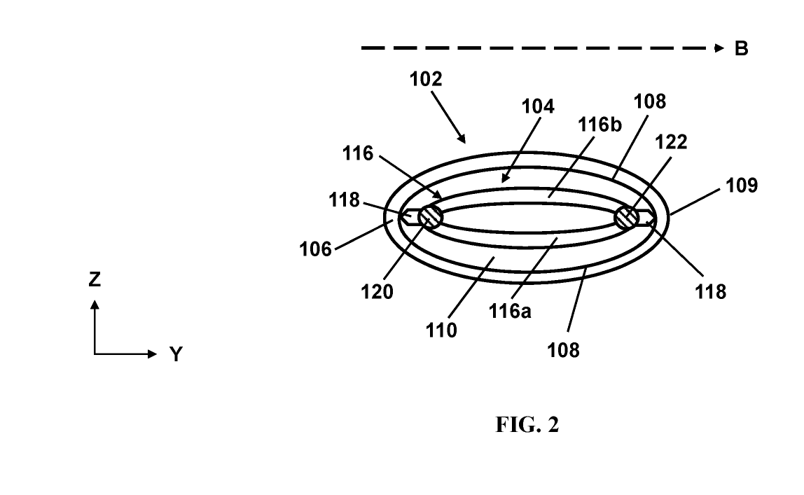

Referring first to component 102, a body 106 of component 102 can be shaped to include one or more interior sidewalls 108 which define a hollow interior 110 of component 102. Interior sidewalls 108 can extend axially along a straight line substantially in parallel to an exterior surface profile 109 of body 106. In alternative embodiments, interior sidewalls 108 can be sloped inward or outward relative to exterior surface profile 109 of body 106, e.g., such that a cross-section of hollow interior 110 is non-uniform or location-dependent. In some embodiments, the cross-sectional area of hollow interior 110 may be greatest and/or lowest at predetermined axial location(s) of hollow interior 110. In the accompanying figures, the axial direction of component 102 and support package 104 is shown to be parallel with X axis. Hollow interior 110 is shown to have a uniform cross-section in the accompanying figures solely for ease of explanation. As shown in FIG. 2 and described elsewhere herein, interior sidewall(s) 108 can define a substantially rounded geometry (e.g., circular, ovular, etc.), or alternatively can form other geometries such as a triangular, quadrilateral, and/or other multi-sided interior geometry similar to or different that from exterior surface profile 109 of component 102.

Body 106 can further include a closed first end 112, in addition to a hollow second end 114 each connected to respective axial ends of interior sidewalls 108. Interior sidewalls 108 are thus shown to extend axially between closed first end 112 and hollow second end 114. In additive manufacture, a “build direction” of one or more components may be defined by a fabricator before raw materials are processed from raw materials into a desired structure. A build direction for a given component and/or sub-component therefore defines the order in which structural features are formed over time as raw materials (e.g., metallic powders) are sintered to form a structure. Such materials can include, e.g., one or more pure metals and/or alloys including without limitation: Copper (Cu), Chromium (Cr), Titanium (Ti), Nickel (Ni), aluminum (Al), etc. In an example embodiment, a build direction “B” of component 102 can be oriented substantially along Y-axis. In this case, one interior sidewall 108 of body 106 is formed before closed first end 112, followed by the remaining and/or remainder of interior sidewall 108. The orientation of build direction B can therefore cause one interior sidewall 108 or portion thereof to be the last part of body 106 formed during manufacture. If support package 104 is not manufactured with component 102, interior sidewall 108 may not have substantial structural support. Forming support package 104 as an integral structural portion of component 102 during manufacture can permit interior sidewall(s) 108 to be formed on a plurality of supports 116 of support package 104, in addition to previously formed portions of body 106.

Hollow interior 110 of component 102 can be defined by closed first end 112 and interior sidewalls 108. Hollow second end 114 can provide an open connection between the external environment and hollow interior 110 of component 102. As discussed in further detail elsewhere herein, component 102 can be shaped to form any desired geometry with interior sidewalls 108, closed first end 112, and hollow second end 114, and in example embodiments may be substantially cylindrical, triangular, rectangular, polygonal, etc. As such, interior sidewall(s) 108 may be respective portions of a single continuous interior sidewall of component 102, but can be defined as opposing interior sidewall(s) 108 by having respective components and/or features connected thereto. Regardless of the geometrical shape and configuration of component 102, component 102 can be composed of one or more laser-sintered metals or metallic materials, e.g., those currently-known or later developed for use in an additive manufacturing process.

Support package 104 may be positioned substantially within hollow interior 110 of component 102. Support package 104 can be formed together with component 102, and thus and may include one or more of the same materials (e.g., laser-sintered metals and/or similar metallic components) included within component 102 as described elsewhere herein. Support package 104 can include supports 116 extending between interior sidewalls 108 of component 102. Each support 116 can extend through a cross-section of hollow interior 110 to form a structural connection between interior sidewalls 108. Supports 116 can thus be shaped to complement a geometrical profile of interior sidewalls 108, e.g., by having an end-to-end length substantially equal to that of the portion of hollow interior 110 where support(s) 116 are positioned. In some cases, supports 116 can extend substantially in parallel with closed first end 112 and/or hollow second end 114. Although ten supports 116 are shown in the accompanying figures for the purposes of demonstration, it is understood that the total number of supports 116 in support package 104 can vary between implementations. For instance, some support packages 104 may include, e.g., one support 116, five supports 116, fifty supports 116, one-hundred or more supports 116, etc.

Each support 116 can contact interior sidewalls 108 through a breakable joint 118. Breakable joint 118 can be formed from the same materials composition as support(s) 116 and a remainder of component 102, yet may be structurally distinct by having a greatly reduced cross-section relative to the remainder of support(s) 116. In an example embodiment, a cross-section of support(s) 116 can be reduced by, e.g., at least approximately ninety percent proximal to respective interior sidewalls 108. In an example embodiment, support 116 can have a cross-sectional diameter of approximately five centimeters (cm) within hollow interior 110, but may have a reduced cross-sectional diameter of, e.g., 0.5 cm or 0.05 cm proximal to interior sidewall(s) 108. Breakable joints 118 can thus be shaped to facilitate removal from component 102 in embodiments of the present disclosure, yet can be manufactured as a structurally integral piece of component 102 and/or support package 104. Breakable joints 118 can be formed in pairs at opposing ends of each support 116, such that supports 116 are mechanically coupled to interior sidewalls 110 of component 102 at opposing ends.

Support package 104 can further include a first rod 120 positioned proximal to one end of multiple support(s) 116 and one interior sidewall 108 of component 102, and a second rod 122 positioned proximal to another interior sidewall 108 of component 102. First and second rods 120, 122 can have a different orientation from supports 116, and in an example embodiment can extend transversely and/or substantially in parallel with interior sidewall(s) 108 of component 102. First and second rods 120, 122 are illustrated with cross-hatching solely to emphasize differences in position and/or intended use relative to other components of component 102 and/or support package 104. It is understood that first and second rods 120, 122 may have the same material composition as the remainder of component 102, e.g., body 106, closed first end 112, supports 116, breakable joints 118, etc. Specifically, first and second rods 120, 122, may also be composed of a laser-sintered metal and/or metallic material such as those currently-known or later developed in the field of additive manufacture.

First and/or second rods 120, 122 may terminate axially at a first end E₁ positioned at or proximal to support(s) 116 located closest to closed first end 112 of body 106. However, first and second rods 120, 122 may be structurally separated and/or independent from closed first end 112 of component 102. An axial gap 124 within hollow interior 110 can therefore separate first and second rods 120, 122 from closed first end of body 106, such that first closed end. As described elsewhere herein, axial gap 124 can provide a space for rods 120, 122 to travel when being struck during removal of support package 104 from component 102. First rod 120 can include an opposing end E2 positioned outside component 102 and opposite first end E₁. Second rod 122 can include an opposing end E₃ positioned outside component 102 and opposite first end E₁. Each end E₁, E₂, E₃ of rods 120, 122 can exhibit, e.g., a flat axial shape to permit direct engagement with other flat surfaces during removal of support package 104, as described elsewhere herein. In alternative embodiments, each end E₁, E₂, E₃ of rods 120, 122 can have a non-flat shape (e.g., curved, grooved, recessed, notched, etc.) for engaging similarly or complementarily-shaped instruments for contacting rods 120, 122. Differences in size between first and second rod 120, 122 can cause second and third ends E₂, E₃ to be separated by a linear differential 126. In an example embodiment, second rod 122 can be greater in length than first rod 120 or vice versa. As described elsewhere herein, linear differential 126 can allow first rod or second rod 120, 122 to be struck before the other as support package 104 is being removed from component 102.

Turning to FIG. 2, a cross-sectional view of component 102 and support package 104 in plane Y-Z is provided to further illustrate structural features of component 102 and support package 104. In particular, each support 116 can optionally include multiple segments 116a, 116b, which can be shaped to complement an interior geometry of component 102 and/or interior sidewalls 108. For example, where hollow interior 110 of component 102 has a substantially ovular cross-section, support(s) 116 can include segments 116a, 116b which are semi-ovular in shape and each coupled to first and second rods 120, 122 proximal to breakable joints 118. When component 102 and support package 104 is fabricated along build direction B, first rod 120 can be formed before segments 116a, 116b, which are formed simultaneously with respective portions of body 106, and before second rod 122 and/or other breakable joints 118 are formed. It is also understood that support(s) 116 may not include segments 116a, 116b where desired, or that more than two segments 116a, 116b (e.g., three, five, ten, fifteen, twenty segments, etc.) may be formed. In addition, the shape of segments 116a, 116b for each support 116 can vary based on the shape of interior sidewall(s) 108. Although first and second rods 120, 122 are shown by example to include a solid cross-section, embodiments of the present disclosure can include rods 120, 122 which include wholly or partially hollow cross-sections in plane Y-Z.

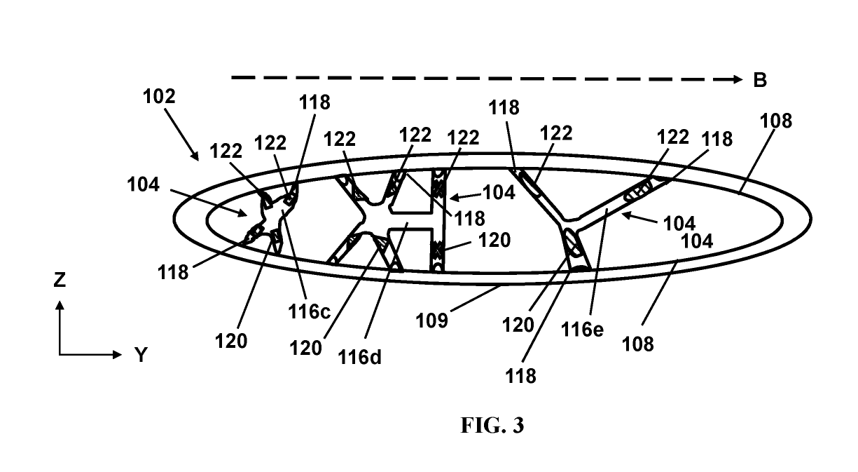

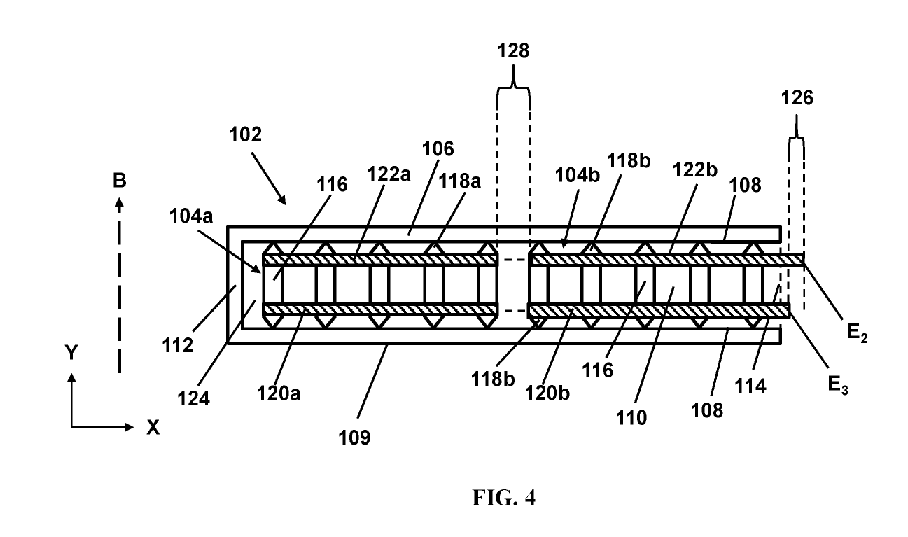

Referring to FIG. 3, a cross-sectional view of component 102 and support package 104 is shown to illustrate alternative embodiments of the present disclosure. As noted elsewhere herein, supports 116 can be formed to take on a variety of shapes, cross-sectional profiles, etc., to accommodate variously shaped component(s) 102 and/or intended applications. Thus, support packages 104 are shown in FIG. 4 to include complex and/or composite geometries between respective interior sidewalls 108. For example, support 116c is shown to be substantially X-shaped, support 116d is shown to include a composite geometry including X and T shapes, while support 116e is shown to be substantially Y-shaped. In addition to varying the shape of each support 116, support packages 104 can include variably shaped first and second rods 120, 122, which may have non-circular cross-sections. For instance, first and second rods 120, 122 in support 116c may be substantially rectangular, first and second rods 120, 122 in support 116d may be substantially triangular and/or X-shaped, while first and second rods 120, 122 in support 116e may have irregular or non-polygonal cross-sectional geometries. Varying the shape of rods 120, 122 may yield technical benefits in various applications of the present disclosure, e.g., by accounting for longer or shorter separation distances between supports 116 to prevent local overhangs during the fabrication or removal of support packages 104. In still other embodiments, rods 120, 122 may be structurally connected to support(s) 116 through additional breakable joints 118, such that some breakable joints 118 connect rods 120, 122 to supports 116 while other breakable joints 118 connect supports 116 to interior sidewall(s) 108.

Regardless of the shape in which supports 116 and rods 120, 122 are formed, embodiments of the present disclosure can be formed along build direction B and/or implemented after manufacture pursuant to the same principles as other embodiments described explicitly herein. Furthermore, each support package 104 may include additional first and/or second rods 120, 122 therein such that the total number of rods 120, 122 in each support package may include, e.g., three rods, four rods, six rods, ten rods, fifty rods, one-hundred or more rods, etc. It is therefore understood that support packages 104 may have one or multiple first rods 120, one or multiple second rods 122, one or multiple supports 116a (FIG. 3), 116b (FIG. 3), 116c, 116d, 116e, etc., with any geometrical configuration shown explicitly herein and/or alternative geometrical configurations apparent to those of ordinary skill in the art.

Turning to FIG. 4, further embodiments of component 102 and support package 104 are shown. In particular, one component 102 can include multiple support packages 104a, 104b positioned substantially in axial alignment with each other. Each support package 104a, 104b can include respective sets of supports 116 breakable joints 118a, 118b, rods 120a, 120b, 122a, 122b, etc., formed substantially in the same manner as the single support package 104 described elsewhere herein. Each support package 104a, 104b can be composed of similar or identical materials, including those described elsewhere herein with respect to component 102 and/or a single package 104. Further, support packages 104a, 104b can be connected to interior sidewalls 108 through breakable joints 118a, 118b as described elsewhere herein. Axially adjacent support packages 104a, 104b can be substantially aligned with each other such that an axial gap 128 separates each support package 104a, 104b, within hollow interior 110 of component 102. First and second rods 120a, 120b, 122a, 122b, may be shaped to have different axial lengths depending on the size and shape of hollow interior 110.

Support packages 104a, 104b may be structurally independent from each other yet positioned in the same hollow interior 110 of component 102. Although two support packages 104a, 104b are illustrated by example in FIG. 4, it is understood that component 102 can be fabricated to include any desired number of support packages 104 therein, with support package(s) 104 being substantially axially aligned end-to-end with other support package(s) 104 through first and second rods 120, 122. More specifically, rods 120, 122 of each support package 104 can be substantially aligned with their counterparts in other support package(s) 104. As described elsewhere herein, an axial striking force can be imparted to rods 120b, 122b of one support package 104b can destroy breakable joints 116b dislodge rods 120b, 122b thereof from component 102. The dislodged rods 120b, 122b can then contact axially aligned rods 120a, 122a of another support package 104a to also destroy breakable joints 116a thereof. The relative positioning of each support package 104a, 104b can therefore allow both support packages 104a, 104b to be removed in a single process, e.g., by striking only one support package 104b.

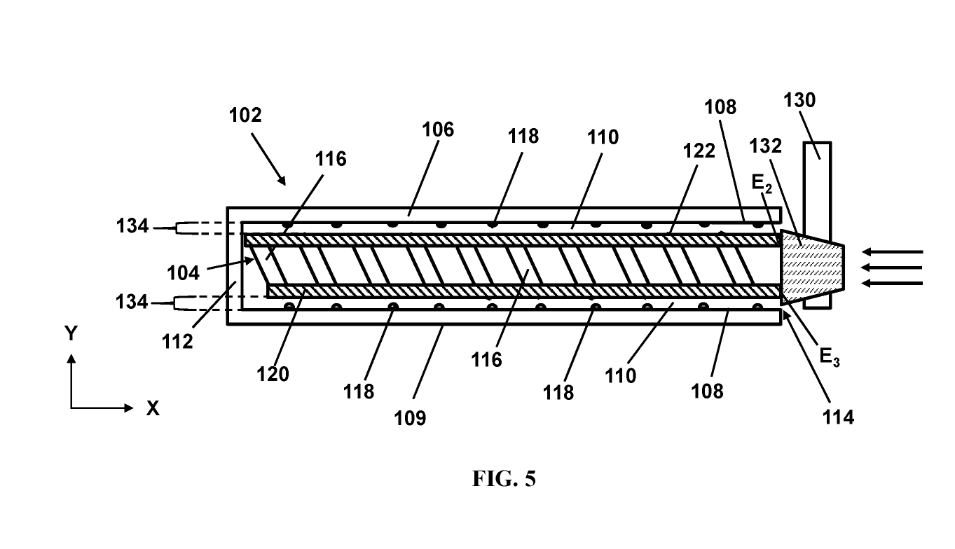

Turning to FIG. 5, embodiments of the present disclosure provide methods for removing support package(s) 104 from component 102. Methods according to the present disclosure can include providing component 102 with opposing interior sidewalls 108, as described elsewhere herein and illustrated in FIGS. 1-4. In particular, component 102 can be manufactured using build direction B (FIGS. 1-4) to form first rod 120, supports 116, and second rod 122 on one interior sidewall 108 of body 106, before forming a remainder or other interior sidewall 108 thereon. Methods according to the present disclosure can include dislodging and removing support package(s) 104 from component 102 after manufacture by striking predetermined elements of support package(s) 104, e.g., rods 120, 122.

Breakable joints 118 may become dislodged from interior sidewalls 108 without remaining portions of supports 116 being damaged, e.g., by having a greatly reduced material strength as a result of having a reduced cross-section relative to the remainder of support(s) 116. Methods according to the present disclosure can include, e.g., striking first rod 120 of support package 104 with a force which overcomes the material strength of breakable joints 118 from interior sidewall 108. Thereafter, second rod 122 may also be struck with a force that is at least sufficient to destroy any remaining breakable joints 118 which joined second rod 122 to interior sidewall 108. Methods according to the present disclosure can include striking first and second rods 120, 122 at hollow second end 114 positioned opposite closed first end 112 of component 102.

First and second rods 120, 122 can be struck, e.g., using a striking tool 130 with an operative head 132 shaped to sequentially or simultaneously contact first and second rods 120, 122. As examples, striking tool 130 can be embodied as, e.g., a hammer (including, e.g., mechanically-driven hammers, electrically-driven hammers, pneumatically-driven hammers, etc.), a stamping instrument, a press, a milling surface, etc. To provide ease of contact between striking tool 130 and rods 120, 122, operative head 132 can include a contact surface for sequentially striking axial ends of first and second rods 120, 122, which may include a flat or complementary shape such that operative head 132 easily contacts rods 120, 122. In an example embodiment, first rod 120 and second rod 122 may have different lengths, thereby causing operative head 132 to contact second rod 120 before contacting first rod 122. Thus, the shape of striking tool 130 and rods 120, 122 can cause breakable joints 118 of both rods 120, 122 to be dislodged from interior sidewalls 108 in a single striking motion.

Support package 104 can be shaped to deform when breakable joints 118 have been broken. In particular, supports 116 may become slanted as a result of one rod 120, 122 being struck before another when breakable joints 118 are dislodged from interior sidewall(s) 108 of component 102. After both rods 120, 122 have been struck, each of the plurality of supports 116 can become oriented at a non-perpendicular angle relative to interior sidewall(s) 108 of component 102. The deformation of supports 116 can reduce the span of package 104 between interior sidewalls 108, such that gaps 134 separate package 104 from interior sidewalls 108. Where rods 120, 122 are shaped to have different lengths, first and/or second rod 120, 122 can axially contact closed first end 112 after rods 120, 122 have been struck. In any event, support package 104 can then be removed from component 102, e.g., by allowing package 104 to slide and/or fall out of hollow interior 110. Methods according to the present disclosure can thereby allow component 102 to be manufactured substantially along build direction B (FIGS. 1-4) with support package 104 therein, before removing support package 104 according to methods of the present disclosure.

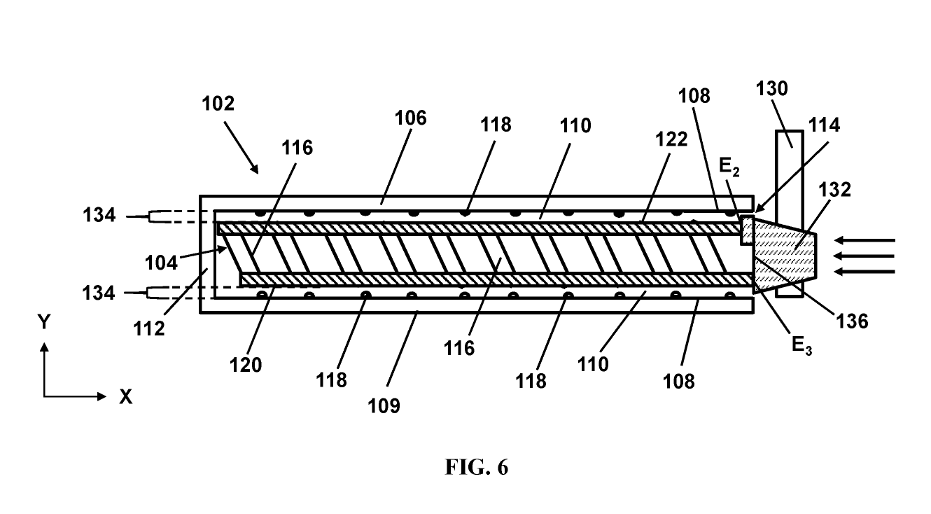

Referring to FIG. 6, further embodiments of a method for removing support package 104 from component 102 are shown. In some cases, support package(s) 104 may be manufactured such that each rod 120, 122 has substantially the same length. However, a user may wish to remove one rod 120, 122 before another in a single striking motion during the removing of support package 104. To provide this functionality, methods according to the present disclosure can include striking rods 120, 122 with striking tool 130 which includes a stepped contact surface 136 of operative head 132. In particular, stepped contact surface 136 can be shaped to contact second rod 122 before contacting first rod 120, thereby dislodging support package 104 at breakable joints 118 of second rod 122 before those of first rod 120. Stepped contact surface 136 of operative head 132 can thereby cause second rod 122 to be removed before first rod 120 even when rods 120, 122 have substantially the same axial length.

The above-described component 102, support package 104, and parts thereof can be manufactured using any now known or later developed technologies, e.g., machining, casting, etc. In one embodiment, however, additive manufacturing is particularly suited for manufacturing component 102, i.e., body 106, interior sidewalls 108, supports 116, breakable joints 118, first rod 120, second sod 122, etc. As used herein, additive manufacturing (AM) may include any process of producing an object through the successive layering of material rather than the removal of material, which is the case with conventional processes. Additive manufacturing can create complex geometries without the use of any sort of tools, molds or fixtures, and with little or no waste material. Instead of machining components from solid billets of metal, much of which is cut away and discarded, the only material used in additive manufacturing is what is required to shape the part. Additive manufacturing processes may include but are not limited to: 3D printing, rapid prototyping (RP), direct digital manufacturing (DDM), selective laser melting (SLM) and direct metal laser melting (DMLM). In the current setting, DMLM has been found advantageous.

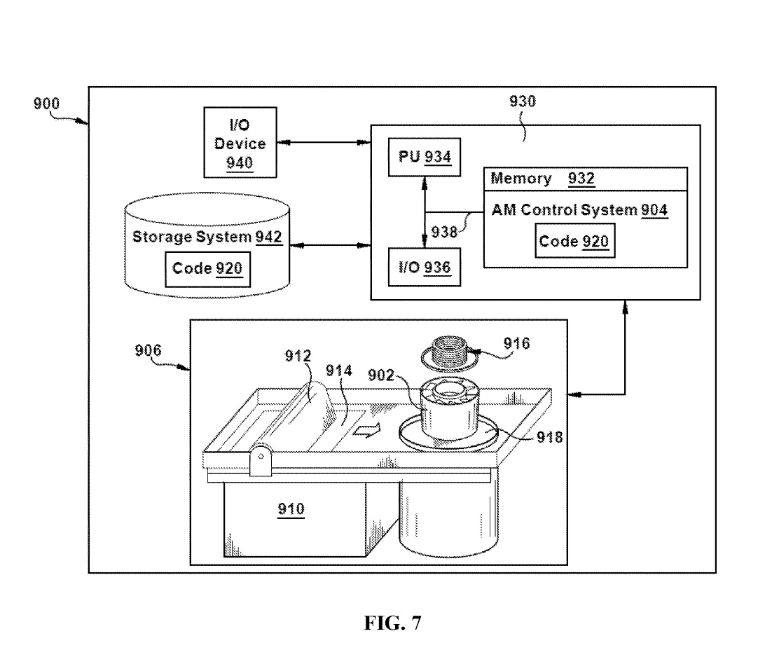

To illustrate an example additive manufacturing process, FIG. 7 shows a schematic/block view of an illustrative computerized additive manufacturing system 900 for generating an object 902. In this example, system 900 is arranged for DMLM. It is understood that the general teachings of the disclosure are equally applicable to other forms of additive manufacturing. Object 902 is illustrated as a double walled turbine element; however, it is understood that the additive manufacturing process can be readily adapted to manufacture component 102 (FIGS. 1-6) with removable support package 104 (FIGS. 1-6) therein. AM system 900 generally includes a computerized additive manufacturing (AM) control system 904 and an AM printer 906. AM system 900, as will be described, executes code 920 that includes a set of computer-executable instructions defining component 102 with removable support package 104 to physically generate one or more of these objects using AM printer 906. Each AM process may use different raw materials in the form of, for example, fine-grain powder, liquid (e.g., polymers), sheet, etc., a stock of which may be held in a chamber 910 of AM printer 906. In the instant case, component 102 and package 104 may be made of stainless steel or similar materials. As illustrated, an applicator 912 may create a thin layer of raw material 914 spread out as the blank canvas from which each successive slice of the final object will be created. In other cases, applicator 912 may directly apply or print the next layer onto a previous layer as defined by code 920, e.g., where the material is a polymer. In the example shown, a laser or electron beam 916 fuses particles for each slice, as defined by code 920. Various parts of AM printer 906 may move to accommodate the addition of each new layer, e.g., a build platform 918 may lower and/or chamber 910 and/or applicator 912 may rise after each layer.

AM control system 904 is shown implemented on computer 930 as computer program code. To this extent, computer 930 is shown including a memory 932, a processor 934, an input/output (I/O) interface 936, and a bus 938. Further, computer 930 is shown in communication with an external I/O device/resource 940 and a storage system 942. In general, processor 934 executes computer program code, such as AM control system 904, that is stored in memory 932 and/or storage system 942 under instructions from code 920 representative of component 102 (FIGS. 1-6) with package 104 (FIGS. 1-6), described herein. While executing computer program code, processor 934 can read and/or write data to/from memory 932, storage system 942, I/O device 940 and/or AM printer 906. Bus 938 provides a communication link between each of the components in computer 930, and I/O device 940 can comprise any device that enables a user to interact with computer 940 (e.g., keyboard, pointing device, display, etc.). Computer 930 is only representative of various possible combinations of hardware and software. For example, processor 934 may comprise a single processing unit, or be distributed across one or more processing units in one or more locations, e.g., on a client and server. Similarly, memory 932 and/or storage system 942 may reside at one or more physical locations. Memory 932 and/or storage system 942 can comprise any combination of various types of non-transitory computer readable storage medium including magnetic media, optical media, random access memory (RAM), read only memory (ROM), etc. Computer 930 can comprise any type of computing device such as a network server, a desktop computer, a laptop, a handheld device, a mobile phone, a pager, a personal data assistant, etc.

Additive manufacturing processes begin with a non-transitory computer readable storage medium (e.g., memory 932, storage system 942, etc.) storing code 920 representative of component 102 (FIGS. 1-6) with package 104 (FIGS. 1-6). As noted, code 920 includes a set of computer-executable instructions defining outer electrode that can be used to physically generate the tip, upon execution of the code by system 900. For example, code 920 may include a precisely defined 3D model of outer electrode and can be generated from any of a large variety of well-known computer aided design (CAD) software systems such as AutoCAD®, TurboCAD®, DesignCAD 3D Max, etc. In this regard, code 920 can take any now known or later developed file format. For example, code 920 may be in the Standard Tessellation Language (STL) which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 920 may be translated between different formats, converted into a set of data signals and transmitted, received as a set of data signals and converted to code, stored, etc., as necessary. Code 920 may be an input to system 900 and may come from a part designer, an intellectual property (IP) provider, a design company, the operator or owner of system 900, or from other sources. In any event, AM control system 904 executes code 920, dividing component 102 and package 104 into a series of thin slices that it assembles using AM printer 906 in successive layers of liquid, powder, sheet or other material. In the DMLM example, each layer is melted to the exact geometry defined by code 920 and fused to the preceding layer. Subsequently, the outer electrode may be exposed to any variety of finishing processes, e.g., minor machining, sealing, polishing, assembly to other part of component 102 (FIGS. 1-6) or package 104 (FIGS. 1-6), etc.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for removing a support package from a laser-sintered component, the method comprising:
providing a laser-sintered component having opposing interior sidewalls, the opposing interior sidewalls defining a hollow interior of the laser-sintered component, wherein the laser-sintered component further includes:
a plurality of supports extending between the opposing interior sidewalls,
a first rod joining the plurality of supports at a first end proximal to one of the opposing interior sidewalls, and
a second rod joining the plurality of supports at a second end proximal to another one of the opposing interior sidewalls;
striking the first rod of the laser-sintered component to dislodge the plurality of supports from one of the opposing interior sidewalls; and
striking the second rod of the laser-sintered component to dislodge the plurality of supports from the other of the opposing interior sidewalls, wherein each of the plurality of supports is oriented at a non-perpendicular angle relative to the opposing interior sidewalls after the first and second rods are struck.

2. The method of claim 1, wherein the striking of the first and second rods occurs sequentially in a single striking motion of a striking tool.

3. The method of claim 2, wherein a length of the first rod is greater than a length of the second rod, such that the second rod is struck before the first rod during the single striking motion.

4. The method of claim 1, wherein the striking of the first and second rods includes striking the first and second rod with an operative head having a stepped contact surface, such that the second rod is struck before the first rod.

5. The method of claim 1, wherein the providing includes manufacturing the laser-sintered component such that the first rod, the second rod, and the plurality of supports are formed on one of the opposing interior sidewalls, wherein the other of the opposing interior sidewalls is formed on the plurality of supports.

6. The method of claim 1, wherein the laser-sintered component includes a closed first end and a hollow second end positioned opposite the closed first end, and wherein the striking includes striking the first and second ends at the hollow second end of the laser-sintered component.

7. A removable support package for a laser-sintered component, comprising:
a structure having opposing interior sidewalls, the opposing interior sidewalls defining a hollow interior of the structure;
a plurality of supports extending between the opposing interior sidewalls;
a first rod joining the plurality of supports at a first end thereof proximal to one interior sidewall; and
a second rod joining the plurality of supports at a second end thereof proximal to another interior sidewall of the structure.

8. The removable support package of claim 7, wherein each of the plurality of supports, the first rod, the second rod, and the structure are composed of a same material composition.

9. The removable support package of claim 7, wherein each of the plurality of supports extends substantially in parallel with a closed first end of the structure, and wherein an opposing hollow second end of the structure includes an opening therethrough.

10. The removable support package of claim 9, wherein the first end of the structure is structurally disconnected from the first rod, the second rod, and the plurality of supports.

11. The removable support package of claim 7, further comprising an adjacent removable support package within the structure, wherein the first and second rods are each aligned end-to-end with a rod of the adjacent removable support package.

12. The removable support package of claim 7, wherein a length of the first rod is greater than a length of the second rod.

13. The removable support package of claim 7, wherein each of the first and second rods includes a flat axial end.

14. The removable support package of claim 7, wherein each of the plurality of supports is shaped to complement a geometrical profile of the opposing interior sidewalls.

15. The removable support package of claim 7, wherein each of the plurality of supports is coupled to the opposing interior sidewalls through a respective pair of breakable joints.

16. A non-transitory computer readable storage medium storing code representative of a removable support package for a laser-sintered component, the removable support package being physically generated upon execution of the code, the removable support package comprising:
a structure having opposing interior sidewalls, the opposing interior sidewalls defining a hollow interior of the structure;
a plurality of supports extending between the opposing interior sidewalls;
a first rod joining the plurality of supports at a first end thereof proximal to one interior sidewall; and
a second rod joining the plurality of supports at a second end thereof proximal to another interior sidewall of the structure.

17. The storage medium of claim 16, wherein each of the plurality of supports extends substantially in parallel with a closed first end of the structure, and wherein an opposing hollow second end of the structure includes an opening therethrough.

18. The storage medium of claim 16, wherein each of the plurality of supports is shaped to complement a geometrical profile of the opposing interior sidewalls.

19. The storage medium of claim 18, wherein the first end of the structure is structurally disconnected from the first rod, the second rod, and the plurality of supports.

20. The storage medium of claim 16, wherein each of the first and second rods includes a flat axial end, and wherein a length of the first rod is greater than a length of the second rod.
